(19) United States
(12) Patent Application Publication
(10) Pub. No.: US 2013/0207961 A1
(43) Pub. Date: Aug. 15, 2013

(54) DRIVING DEVICE, DISPLAY DEVICE INCLUDING THE SAME AND DRIVING METHOD THEREOF

(71) Applicants: Dong-Won PARK, Hwaseong-si (KR); Jae Sung BAE, Suwon-si (KR); Bong Hyun YOU, Yongin-si (KR); Jin Pil KIM, Suwon-si (KR); Seok Ha HONG, Yongin-si (KR)

(72) Inventors: Dong-Won PARK, Hwaseong-si (KR); Jae Sung BAE, Suwon-si (KR); Bong Hyun YOU, Yongin-si (KR); Jin Pil KIM, Suwon-si (KR); Seok Ha HONG, Yongin-si (KR)

(73) Assignee: SAMSUNG DISPLAY CO., LTD., Yongin-City (KR)

(21) Appl. No.: 13/484,890

(22) Filed: May 31, 2012

(30) Foreign Application Priority Data
Feb. 14, 2012 (KR) 10-2012-0015053

(51) Int. Cl. G09G 5/00

(52) U.S. Cl. 345/214

(57) ABSTRACT

A driving device includes a synchronization unit which receives a plurality of input control signals and a plurality of input image signals during a frame through a plurality of channels, where the synchronization unit generates and outputs a synchronization control signal of the plurality of input image signals based on the plurality of input control signals, and a signal controller which receives the plurality of input control signals and the synchronization control signal from the synchronization unit.

This application claims priority to Korean Patent Application No. 10-2012-0015053, filed on Feb. 14, 2012, and all the benefits accruing therefrom under 35 U.S.C. §119, the content of which in its entirety is herein incorporated by reference.

### BACKGROUND

(a) Field

Exemplary embodiments of the invention relate to a driving device, a display device including the driving device, and a driving method thereof.

(b) Description of the Related Art

In general, flat panel displays, such as a liquid crystal display, an organic light emitting diode display, and the like, receive input image data from an external image data supply source, such as a computer, by wired or wireless to process the received input image data. In the flat panel displays, Interfaces for receiving the input image data from the external image data supply source may be variously determined based on standards. Among the standards, a standard corresponding to digital image data, such as a digital visual interface (“DVI”), has been largely applied.

The DVI may be in a single-link transmission mode or a dual-link transmission mode based on a transition minimized differential signaling (“TMDS”) according to resolution of the input image data. In the DVI, for example, when resolution of 1920×2160 of 60 hertz (Hz) is implemented, the single-link mode may be applied, and when higher resolution than the resolution of 1920×2160 of 60 Hz is implemented, the dual-link mode may be applied. Each link of the TMDS may include a plurality of channels, which transmit the input image data, an input control signal, and the like.

In the DVI, the received input image data needs to be variously processed before being inputted to a display panel as a data signal. For example, in a local dimming driving method, in which luminance of a backlight unit that supplies light to the display panel is controlled according to an image, the input image data needs to be rearranged. When a high-resolution motion picture is displayed, an interpolation frame, in which a motion is interpolated, is generated and inserted to reduce motion blurring and the like. As described above, in processing of various input image data, when the input image data inputted through different links or channels are not synchronized with each other before the processing, the image may be abnormally displayed on the display panel.

### SUMMARY

Exemplary embodiments of the invention relate to a display device with reduced display defect by synchronizing a plurality of input image data with each other and to a driving method thereof.

An exemplary embodiment of the invention provides a driving device including a synchronization unit which receives a plurality of input control signals and a plurality of input image signals during a frame through a plurality of channels, where the synchronization unit generates and outputs a synchronization control signal which is common for the plurality of input image signals based on the plurality of input control signals; and a signal controller which receives the plurality of input control signals and the synchronization control signal from the synchronization unit.

An alternative exemplary embodiment of the invention provides a display device including a synchronization unit which receives a plurality of input control signals and a plurality of input image signals during a frame through a plurality of channels, where the synchronization unit generates and outputs a synchronization control signal of the plurality of input image signals based on the plurality of input control signals, a signal controller which receives and processing the plurality of input control signals and the synchronization control signal from the synchronization unit, where the signal controller outputs a driving control signal and an output image signal, and a display panel which receives the driving control signal and the output image signal from the signal controller to display an image.

In an exemplary embodiment, the synchronization unit may include a plurality of receivers which receives the plurality of input control signals and the plurality of input image signals through the plurality of channels, respectively, and a synchronization buffer which receives the plurality of input control signals from the plurality of receivers and generates the synchronization control signal, where the synchronization buffer may be synchronized with the synchronization control signal and outputs the plurality of input image signals.

In an exemplary embodiment, the synchronization buffer may include a plurality of controllers which receives the plurality of input control signals and the plurality of input image signals synchronized with the plurality of input control signals from the plurality of receivers, respectively, and a synchronization signal generator which generates the synchronization control signal based on the plurality of input control signals.

In an exemplary embodiment, the synchronization buffer may further include a plurality of memories, the plurality of controllers may stores the plurality of input image signals in the plurality of memories, respectively, and the plurality of memories may receive the synchronization control signal and output the plurality of input image signals in synchronization with the synchronization control signal.

In an exemplary embodiment, the plurality of input control signals may include a plurality of data enable signals, the plurality of controllers may generate a plurality of flag signals based on the plurality of data enable signals, respectively, and transmit the plurality of flag signals to the synchronization signal generator, and the synchronization control signal may include a synchronized data enable signal.

In an exemplary embodiment, the plurality of input control signals may include a plurality of clock signals, and the synchronization control signal may include a master clock signal which is one of the plurality of clock signals.

In an exemplary embodiment, the display device may further include a data processor which receives and processes the synchronization control signal and the plurality of input image signals from the synchronization unit, where the data processor may transmit the processed signals to the signal controller.

In an exemplary embodiment, the display panel may include a plurality of display blocks, the data processor may include a plurality of data processing circuits which processes input image signals such that the processed input image signals are respectively displayed in each of the plurality of display blocks, the signal controller may include a plurality of signal control circuits connected to the plurality of data processing circuits, respectively, and the synchronization unit may transmit the synchronization control signal and the input image signals corresponding to the plurality of display blocks, respectively, to the plurality of data processing circuits.

In an exemplary embodiment, the synchronization buffer may include a line memory.

Another exemplary embodiment of the invention provides a driving method of a display device including receiving a plurality of input control signals and a plurality of input image signals through a plurality of channels, respectively, by a plurality of receivers; receiving the plurality of input control signals from the plurality of receivers by a synchronization buffer; generating and outputting a synchronization control signal of the plurality of input image signals based on the plurality of input control signals by the synchronization buffer; and receiving the plurality of input control signals and the synchronization control signal from the synchronization buffer by a signal controller.

In an exemplary embodiment, the receiving the plurality of input control signals from the plurality of receivers by the synchronization buffer may include receiving the plurality of input image signals by a plurality of controllers of the synchronization buffer, the receiving the plurality of input signals by the plurality of controllers may be in synchronization with the plurality of input control signals, respectively, and the synchronization buffer may be synchronized with the synchronization control signal to output the plurality of input image signals.

In an exemplary embodiment, the driving method of a display device may further include: storing the plurality of input image signals in a plurality of memories of the synchronization buffer, respectively, by a plurality of controllers of the synchronization buffer; receiving the synchronization control signal by the plurality of memories; and outputting the plurality of input image signals in synchronization with the synchronization control signal by the plurality of memories.

In an exemplary embodiment, the driving method of a display device may further include receiving and processing the synchronization control signal and the plurality of input image signals from the synchronization unit by a data processor, and transmitting the processed signals from the data processor to the signal controller.

According to the exemplary embodiments of the invention, display quality is prevented from being deteriorated due to asynchronization by synchronizing image signals or control signals, which are inputted through a plurality of channels or a TMDS link, with each other.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an exemplary embodiment of a display device according to the invention;

FIG. 2 is a block diagram showing an operation of an exemplary embodiment of a synchronization buffer shown in FIG. 1;

FIG. 3 is a signal timing diagram of input and output signals of an exemplary embodiment of a synchronization unit shown in FIG. 1;

FIG. 4 is a block diagram showing an exemplary embodiment of a driving device including a synchronization unit of a display device according to the invention;

FIG. 5 is a block diagram showing an operation of an exemplary embodiment of a synchronization buffer shown in FIG. 4; and

FIG. 6 is a block diagram showing an alternative exemplary embodiment of a display device according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

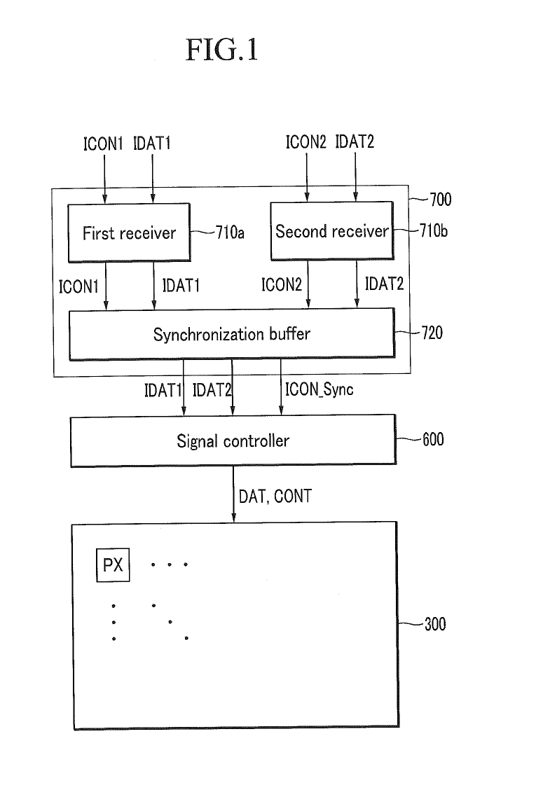

First, an exemplary embodiment of a display device according to the invention will be described with reference to FIGS. 1 to 3.

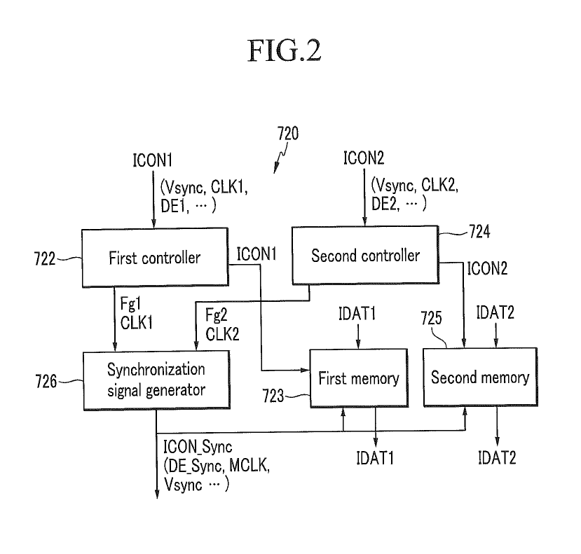

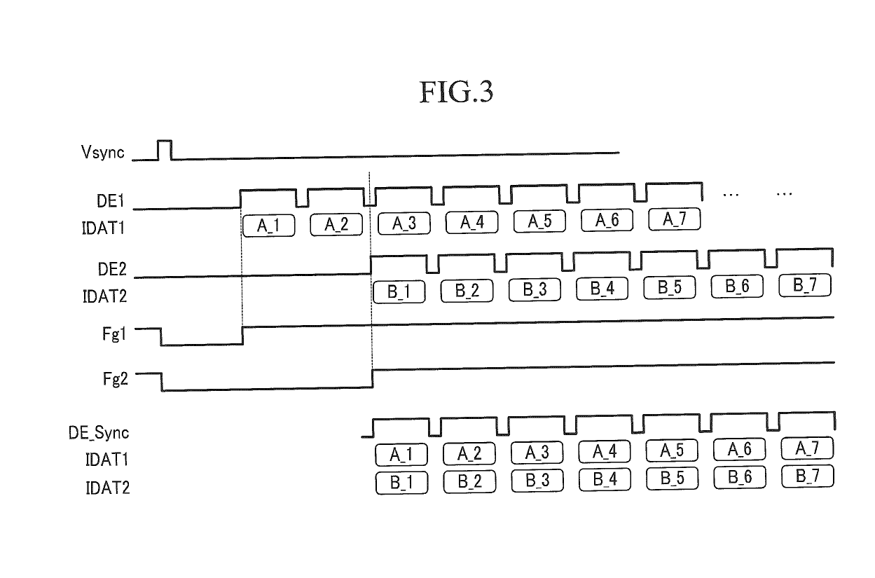

FIG. 1 is a block diagram showing an exemplary embodiment of a display device according to the invention, FIG. 2 is a block diagram showing an operation of an exemplary embodiment of a synchronization buffer shown in FIG. 1, and FIG. 3 is a signal timing diagram showing input and output signals of an exemplary embodiment of a synchronization unit shown in FIG. 1.

Referring to FIG. 1, an exemplary embodiment of the display device according to the invention includes a display panel 300 and a driving device that drives the display panel, and the driving device includes a signal controller (also referred to as “timing controller”) 600 and a synchronization unit 700.

The display panel 300 includes a plurality of pixels PX for displaying an image and at least one driver (not shown) that transmits a driving signal to the plurality of pixels PX. The plurality of pixels PX may be arranged substantially in a matrix form and are connected to a plurality of signal lines that transmits the driving signal. In an exemplary embodiment, the display device may have various resolutions such as 1920×080, 3840×160 or 4096×160, for example, which may be determined based on the arrangement of the plurality of pixels PX.

In an exemplary embodiment, the at least one driver that transmits the driving signal may include a scan driver (not shown) that transmits a scan signal to the signal line of the display panel 300 and a data driver (not shown) that transmits a data signal.

In an exemplary embodiment, the signal controller 600 receives input image signals, e.g., a first input image signal IDAT1 and a second input image signal IDAT2, and a synchronization control signal ICON_Sync during a unit frame from a synchronization buffer 720 and processes the input image signals, IDAT1 and IDAT2 based on the input image signals IDAT1 and IDAT2 and the synchronization control signal ICON_Sync to generate an output image signal DAT during a unit frame and to generate driving control signals CONT for controlling the at least one driver, which drives the display panel 300. The driving control signals CONT may include a scan control signal for controlling a scan driver (not shown) and a data control signal for controlling a data driver (not shown), for example.

In an exemplary embodiment, the signal controller 600 may include n sub signal controllers (here, n is a natural number) based on the resolution of the input image signals IDAT1 and IDAT2, and the data driver of the display panel 300 may also include m data driving circuits (here, m is a natural number). In such an embodiment, the plurality of pixels PX of the display panel 300 may be divided into n display blocks. The signal controller 600 may output the output image signals DAT corresponding to the respective display blocks to the display panel 300 based on the synchronization control signal ICON_Sync.

In an exemplary embodiment, the synchronization unit 700 includes a first receiver 710a, a second receiver 710b and a synchronization buffer 720. In an exemplary embodiment, as shown in FIG. 1, the synchronization unit 700 includes two receivers, e.g., the first and second receivers 710a and 710b, for example, but not being limited thereto. In an alternative exemplary embodiment, the synchronization unit 700 may include various numbers of receivers.

The first receiver 710a receives a first input image signal IDAT1 and a first input control signal ICON1, which are corresponding to each other, during a unit frame from an external system, and the second receiver 710b receives a second input image signal IDAT2 and a second input control signal ICON2, which are corresponding to each other, during a unit frame from the external system.

The first input image signal IDAT1 and the first input control signal ICON1 may be transmitted from different transmitters through a different channel from the second input image signal IDAT2 and the second input control signal ICON2. In an exemplary embodiment, for example, the first input image signal IDAT1 and the first input control signal ICON1, the second input image signal IDAT2 and the second input control signal ICON2 may be transmitted through different signal transmission channels of a single-link of a transition minimized differential signaling (“TMDS”) or through different links of a TMDS dual-link based on the resolution of the display device. In an exemplary embodiment, the first input image signal IDAT1 and the first input control signal ICON1, the second input image signal IDAT2 and the second input control signal ICON2 may be transmitted through the links the TMDS dual-link, each of the links may include at least one signal transmission channel based on the resolution of the display device, a data transmission frequency and a bandwidth of each of the at least one signal transmission channel, for example.

In an exemplary embodiment, the first receiver 710a and the second receiver 710b may receive the first and second input image signals IDAT1 and IDAT2, respectively, and the first and second input control signals ICON1 and ICON2, respectively, in parallel through a low voltage differential signaling (“LVDS”) transmission mode.

The first and second input image signals IDAT1 and IDAT2 include luminance information of the plurality of pixels PX, and the luminance information of each pixel PX has a predetermined value corresponding to a gray level of each pixel to display. In an exemplary embodiment, as shown in FIG. 2, each of the first and second input control signals ICON1 and ICON2 may include a vertical synchronization signal Vsync and a horizontal synchronizing signal, a clock signal, e.g., a first clock signal CLK1 or a second clock signal CLK2 and a data enable signal, e.g., a first data enable signal DE1 or a second data enable signal DE2, for example.

The synchronization buffer 720 receives the first input image signal IDAT1 and the first input control signal ICON1 from the first receiver 710a, and receives the second input image signal IDAT2 and the second input control signal ICON2 from the second receiver 710b. The synchronization buffer 720 may generate the synchronization control signal ICON_Sync using the first input control signal ICON1 and the second input control signal ICON2, and output the input image signals IDAT1 and IDAT2 to the signal controller 600 together with the synchronization control signal ICON_Sync.

In an exemplary embodiment, the first and second input image signals IDAT1 and IDAT2 inputted to the first receiver 710a and the second receiver 710b respectively through different channels or channels of different links are synchronized with each other using the synchronization control signal ICON_Sync to be transmitted and processed

Referring to FIG. 2, in an exemplary embodiment, the synchronization control signal ICON_Sync may include a synchronized data enable signal DE_Sync and a master clock signal MCLK, for example. The master clock signal MCLK may be a single pixel clock signal, which may be commonly used in data transmission and processing after the procession in the synchronization buffer 720. In such an embodiment, the synchronization control signal ICON_Sync may also include a synchronized spread spectrum clock signal. The spread spectrum clock signal is a clock signal generated by modulating a frequency of the inputted clock signal to reduce electromagnetic interference (“EMI”).

Referring to FIG. 2, an exemplary embodiment of the synchronization buffer 720 may include a first controller 722, a second controller 724, a first memory 723, a second memory 725 and a synchronization signal generator 726. However, the number of controllers 722 and 724 and the number of memories 723 and 725 in the synchronization buffer are not limited to the exemplary embodiment shown in FIG. 2. In an alternative exemplary embodiment, each of the number of controllers 722 and 724 and the number of memories 723 and 725 may be one or greater than two.

The first controller 722 receives the first input control signal ICON1 from the first receiver 710a, and the second controller 724 receives the second input control signal ICON2 from the second receiver 710b. In an exemplary embodiment, as shown in FIG. 2, the first input control signal ICON1 and the second input control signal ICON2 include the first and second data enable signals DE1 and DE2, respectively, the first and second clock signals CLK1 and CLK2, respectively, and the vertical synchronization signal Vsync, for example. In an exemplary embodiment, each of the first input control signal ICON1 and the second input control signal ICON2 may further include a spread spectrum clock signal for reducing the EMI.

Referring to FIGS. 2 and 3, the first controller 722 may store the first input image signal IDAT1 received in response to the first input control signal ICON1, such as the first data enable signal DE1, in the first memory 723 on a line-unit-by-line-unit basis (e.g., A_1 to A_7 in FIG. 3), and the second controller 724 may store the second input image signal IDAT2 received in response to the second input control signal ICON2, such as the second data enable signal DE2, in the second memory 725 on a line-unit-by-line-unit basis (e.g., B_1 to B_7 in FIG. 3).

The first controller 722 generates a first flag signal Fg1 using the first input control signal ICON1, and the second controller 724 generates a second flag signal Fg2 using the second input control signal ICON2. In an exemplary embodiment, as shown in FIG. 3, the first and second flag signals Fg1 and Fg2 are generated using the first and second data enable signal DE1 and DE2 of the first and second input control signals ICON1 and ICON2.

Referring to FIG. 3, the first controller 722 may generate the first flag signal Fg1, which has a falling edge when the vertical synchronization signal Vsync becomes a high level and has a rising edge in synchronization with a first pulse of the first data enable signal DE1. The second controller 724 may generate the second flag signal Fg2 having a falling edge when the vertical synchronization signal Vsync becomes a high level and has a rising edge in synchronization with a first pulse of the second data enable signal DE2.

In an exemplary embodiment, the synchronization signal generator 726 may generate the synchronization control signal ICON_Sync using the first and second flag signals Fg1 and Fg2, for example. In an exemplary embodiment, the synchronization control signal ICON_Sync may be a synchronized data enable signal DE_Sync, and may be synchronized with the first and second input control signals ICON1 and ICON2, such as data enable signals DE1 and DE2. In such an embodiment, the rising edge of the synchronized data enable signal DE_Sync corresponds to a rising edge of a flag signal of the first and second flag signals Fg1 and Fg2 that becomes a high level later than the other, e.g., the second flag signal Fg2, as shown in FIG. 3.

In an alternative exemplary embodiment, the synchronization signal generator 726 receives a first clock signal CLK1 and a second clock signal CLK2 from the first controller 722 and the second controller 724, respectively, and generate the master clock signal MCLK, as the synchronization control signal ICON_Sync, which may be commonly used in the transmission and processing of the first and second input image signals IDAT1 and IDAT2. The master clock signal MCLK may be defined as one of the first and second clock signals CLK1 and CLK2 of the first controller 722 and the second controller 724, which receive the first and second data enable signals DE1 and DE2 corresponding to the synchronized data enable signal DE_Sync.

In an exemplary embodiment, the synchronization signal generator 726 provide the synchronization control signal ICON_Sync to the first memory 723 and the second memory 725. The first memory 723 and the second memory 725 output the stored first and second input image signals IDAT1 and IDAT2 on a line-unit-by-line-unit basis in synchronization with the synchronization control signal ICON_Sync, as shown in FIG. 3.

In an exemplary embodiment, the synchronization buffer 720 may be a line memory, but not being limited thereto.

In an alternative exemplary embodiment, the first and second controllers 722 and 724 may be integrated with the first and second receivers 710a and 710b, respectively.

As described above, according to an exemplary embodiment of the invention, when the first and second input image signals IDAT1 and IDAT2 or the first and second input control signals ICON1 and ICON2 are inputted through different channels or different TMDS links and are not synchronized with each other, the first and second input image signals IDAT1 and IDAT2 are outputted in synchronization with each other through the synchronization unit 700, and transmitted and processed using the master clock signal MCLK. In such an embodiment, a display defect due to the asynchronization of the signal is thereby effectively prevented.

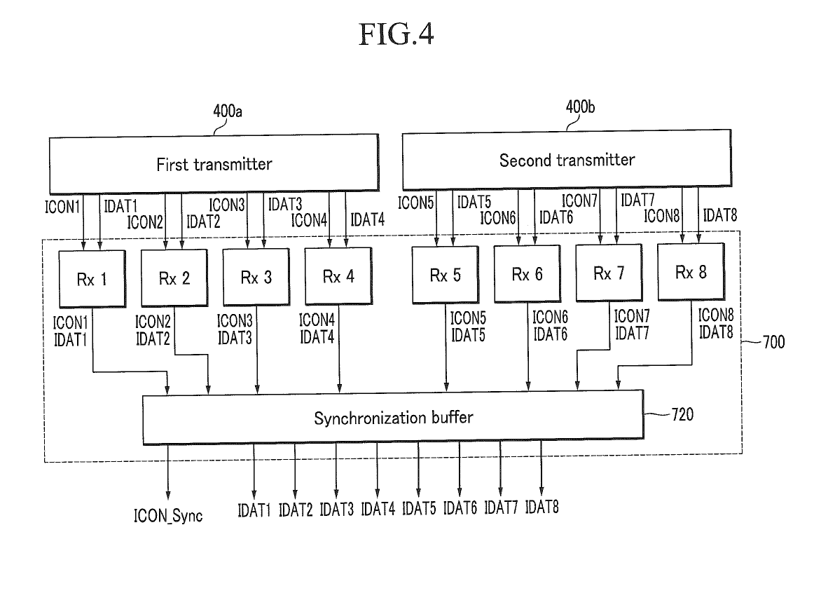

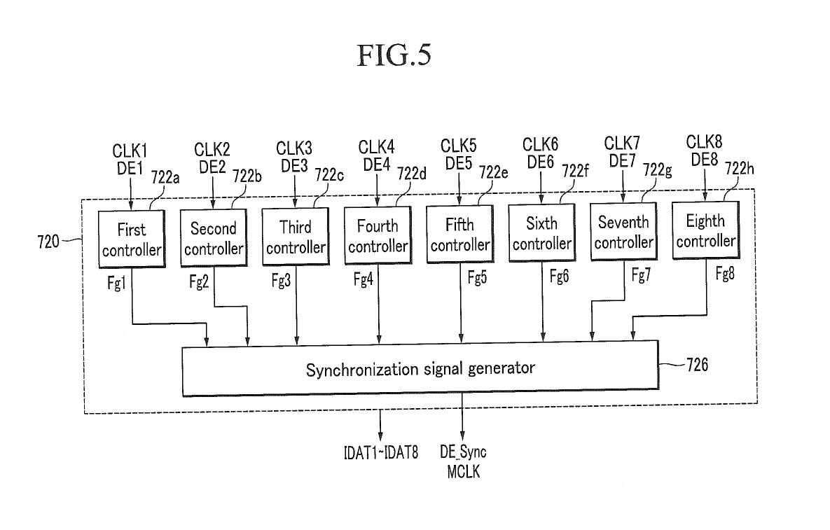

Next, an alternative exemplary embodiment of a display device according to the invention will be described with reference to FIGS. 4 and 5. The same or like elements shown in FIGS. 4 and 5 have been labeled with the same reference characters as used above to describe the exemplary embodiments of the display device shown in FIGS. 1 and 2, and any repetitive detailed description thereof will hereinafter be omitted or simplified.

FIG. 4 is a block diagram showing an exemplary embodiment of a driving device including a synchronization unit of a display device according to the invention, and FIG. 5 is a block diagram showing an operation of an exemplary embodiment of a synchronization buffer shown in FIG. 4.

The display device in FIG. 4 is substantially the same as the exemplary embodiment shown in FIGS. 1 and 2, except for the synchronization unit 700. In an exemplary embodiment, as shown in FIG. 4, the synchronization unit 700 includes a plurality of receivers, e.g., a first receiver Rx1, a second receiver Rx2, a third receiver Rx3 and a fourth receiver Rx4, that receive signals from a first transmitter 400a, a plurality of receivers, e.g., a fifth receiver Rx5, a sixth receiver Rx6, a seventh receiver Rx7 and an eighth receiver Rx8, that receive signals from a second transmitter 400b, and a synchronization buffer 720. In an exemplary embodiment, four receivers Rx1 to Rx4 and Rx5 to Rx8 are connected with each of the first and second transmitters 400a and 400b, respectively, but the invention is not limited thereto. In an alternative exemplary embodiment, the number of the receivers connected to each of the transmitters may vary.

In an exemplary embodiment, each of the first transmitter 400a and the second transmitter 400b may be a TMD transmitter and may be connected with the synchronization unit 700 through a single link. In such an embodiment, each of the first transmitter 400a and the second transmitter 400b may be connected with a plurality of receivers, e.g., the first to fourth receivers Rx1 to Rx4 or the fifth to eighth receivers Rx5 to Rx8, through a plurality of channels.

The first transmitter 400a inputs a plurality of input image signals, e.g., a first input image signal IDAT1, a second input image signal IDAT2, a third input image signal IDAT3 and a fourth input image signal IDAT4, and a plurality of input control signals, e.g., a first input control signal ICON1, a second input control signal ICON2, a third input control signal ICON3 and a fourth input control signal ICON4, to the first to fourth receivers Rx1 to Rx4, respectively, through different channels as shown in FIG. 4. The second transmitter 400b inputs a plurality of input image signals, e.g., a fifth input image signal IDAT5, a sixth input image signal IDAT6, a seventh input image signal IDAT7 and an eighth input image signal IDAT8, and a plurality of input control signals, e.g., a fifth input control signal ICON5, a sixth input control signal ICON6, a seventh input control signal ICON7 and an eighth input control signal ICON8, to the fifth to eighth receivers Rx5 to Rx8, respectively, through different channels, as shown in FIG. 4.

In an exemplary embodiment, the first to fourth receivers Rx1 to Rx4 transmit the first to fourth input image signals IDAT1 to IDAT4 and the first to fourth input control signals ICON1, ICON2 to ICON4 to the synchronization buffer 720, and the fifth to eighth receivers Rx5 to Rx8 transmit the fifth to eighth inputted input image signals IDAT5 to IDAT8 and the fifth to eighth input control signals ICON5 to ICON8 to the synchronization buffer 720.

Referring to FIG. 5, in an exemplary embodiment, the first to eighth input control signals ICON1 to ICON8 may be first to eighth clock signals CLK1 to CLK8 and first to eighth data enable signals DE1 to DE8, for example.

In an exemplary embodiment, the synchronization buffer 720 includes a plurality of controllers, e.g., first to eighth controllers 722a to 722h, and a synchronization signal generator 726. In such an embodiment, the plurality of controllers, e.g., the first to eighth controllers 722a to 722h, receive a plurality of clock signals, e.g., the first to eighth clock signals CLK1 to CLK8, and a plurality of data enable signals, e.g., the first to eighth data enable signals DE1 to DE8, respectively.

In such an embodiment, the first to eighth controllers 722a to 722h generate the first to eighth flag signals Fg1 to Fg8 using the first to eighth data enable signals DE1 to DE8, respectively, and transmit the generated first to eighth flag signals Fg1 to Fg8 to the synchronization signal generator 726. In an exemplary embodiment, the synchronization signal generator 726 may also receive the first to eighth clock signals CLK1 to CLK8.

The synchronization signal generator 726 may generate the synchronization control signal ICON_Sync, such as the synchronized data enable signal DE_Sync, using the plurality of flag signals, e.g., the first to eighth flag signals Fg1 to Fg8. In an exemplary embodiment, each of the plurality of clock signals CLK1 to CLK8 may be defined as the master clock signal MCLK to be outputted. In an exemplary embodiment, the master clock signal MCLK may be one of the first to eighth clock signals CLK1 to CLK8, which is inputted together with one of the first to eighth data enable signals DE1 to DE8, which is the reference of the synchronized data enable signal DE_Sync.

The synchronization buffer 720 outputs the first to eighth input image signals ICON1 to ICON8 based on the synchronization control signal ICON_Sync, and outputs the master clock signal MCLK.

The display device and the driving method thereof according to the exemplary embodiment shown in FIGS. 1 to 3 described above may also be applied to the exemplary embodiment shown in FIGS. 4 and 5.

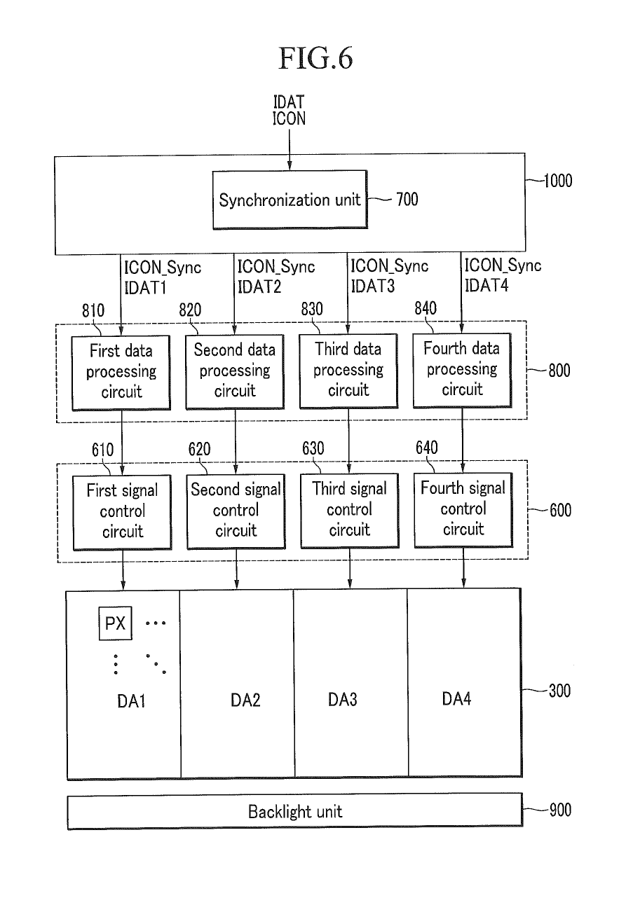

Next, another alternative exemplary embodiment of a display device according to the invention will be described with reference to FIG. 6. The same or like elements shown in FIG. 6 have been labeled with the same reference characters as used above to describe the exemplary embodiments of the display device shown in FIGS. 1 and 2, and any repetitive detailed description thereof will hereinafter be omitted or simplified.

FIG. 6 is a block diagram showing an alternative exemplary embodiment of a display device according to the invention.

As shown in FIG. 6, the display device includes a display panel 300, a backlight unit 900 that provide light to the display panel 300, a signal controller 600, a data processor 800 and a data preprocessor 1000.

The display panel 300 in FIG. 6 is substantially the same as the exemplary embodiment described above, except that the display panel 300 in FIG. 6 is divided into n display blocks (here, n is a natural number). In an exemplary embodiment, as shown in FIG. 6, n is 4, that is, the display panel 300 is divided into four display blocks, e.g., a first display block DA1, a second display block DA2, a third display block DA3 and a fourth display block DA4, but the number of the display blocks is not limited thereto. In an exemplary embodiment, the display device has a resolution of 1920×080, and the display panel 300 may be divided into two display blocks. In an alternative exemplary embodiment, the display device has a high resolution of 3840×160, and the display panel 300 may be divided into four display blocks.

The signal controller 600 in FIG. 6 is substantially the same as the exemplary embodiment described above, except that the signal controller 600 in FIG. 6 include four control circuits, e.g., a first signal control circuit 610, a second signal control circuit 620, a third signal control circuit 630 and a fourth signal control circuit 640, corresponding to the first to fourth display blocks DA1 to DA4, respectively. In an exemplary embodiment, the number of the signal control circuits is also not limited to four, and may be corresponding to the number of the display blocks DA1 to DA4. The signal controller 600 receives an input image signal IDAT and a synchronization control signal ICON_Sync, and generates an output image signal DAT to transmit a driving control signal and the output image signal DAT to the drivers of the display panel 300.

The data processor 800 may include four processing circuits, e.g., a first data processing circuit 810, a second data processing circuit 820, a third data processing circuit 830 and the fourth data processing circuit 840, which are connected to the first to fourth signal control circuits 610 to 640, respectively, to transmit signals, but the number thereof is not limited thereto. The first to fourth data processing circuits 810, 820, 830 and 840 receive the synchronization control signal ICON_Sync and first to fourth input image signals IDAT1, IDAT2, IDAT3 and IDAT4, respectively, from the data preprocessor 1000.

In an exemplary embodiment, the data preprocessor 1000 may include the synchronization unit 700, as described above. The synchronization unit 700 generates a common synchronization control signal ICON_Sync of a plurality of input image signals IDAT based on a plurality of input control signals ICON inputted through a plurality of channels or links to input the common synchronization control signal ICON_Sync to the data processor 800. Since other features of the synchronization unit 700 are substantially the same as the features of the synchronization unit 700 shown in FIGS. 1 and 2, any repetitive detailed description thereof will be omitted.

The data preprocessor 1000 receives the plurality of input image signals IDAT and the plurality of input control signals ICON from an external system through a plurality of channels or a plurality of TMDS links to process the signals, and input the processed signals to the data processor 800.

The data preprocessor 1000 may be variously modified according to functions of the data processor 800. In one exemplary embodiment, for example, the data processor 800 includes a frame rate controller (“FRC”), and the data preprocessor 1000 may be a data repeater. In an exemplary embodiment, the backlight unit 900 is divided into a plurality of light emitting blocks and driven by a local dimming driving method of controlling a light amount of the light emitting blocks in response to luminance of images corresponding to the light emitting blocks. In such an embodiment, the data preprocessor 1000 may include a circuit unit which processes the input image signal IDAT for the local dimming driving.

First, an exemplary embodiment of the data preprocessor 1000 that serves as a data repeater will be described. In such an embodiment, the data preprocessor 1000 may receive the input image signal IDAT of a unit frame having a resolution of 3840×160 at a frame frequency of about 60 hertz (Hz) lower than a display frequency from an external system, and the display panel 300 may display the image of a unit frame having a resolution of 3840×160 at a frame frequency of about 120 Hz.

As described above, an exemplary embodiment of the data preprocessor 1000 may receive the input image signal IDAT of a unit frame having resolution of 3840×160 and the input control signal ICON from an external system at a frame frequency of about 60 Hz. In such an embodiment, the input image signal IDAT and the input control signal ICON may be inputted through different channels or different TMDS links.

The data preprocessor 1000 may transmit the first to fourth input image signals IDAT1, IDAT2, IDAT3 and IDAT4 of a unit frame having a resolution of 960×160 and a synchronization control signal ICON_Sync to the data processor 800 through four output terminals, respectively. The first input image signal IDAT1 corresponding to the first display block DA1 is inputted to the first data processing circuit 810 of the data processor 800, the second input image signal IDAT2 corresponding to the second display block DA2 is inputted to the second data processing circuit 820, the third input image signal IDAT3 corresponding to the third display block DA3 is inputted to the third data processing circuit 830, the fourth input image signal IDAT4 corresponding to the fourth display block DA4 is inputted to the fourth data processing circuit 840, and the synchronization control signal ICON_Sync may be inputted to all of the first to fourth data processing circuits 810 to 840.

In an exemplary embodiment, where the resolution of the input image signal IDAT inputted from the external system is different from the resolution of a unit frame image to be displayed in the display panel 300, a scaler (not shown) may be provided between the data preprocessor 1000 and the external system to control the input image signal IDAT to be corresponding to the resolution of the display panel 300.

In an exemplary embodiment, each of the first to fourth data processing circuits 810, 820, 830 and 840 may include a frame rate controller, for example. In such an embodiment, each of the first to fourth data processing circuits 810, 820, 830 and 840 may receive a corresponding input image signals, e.g., one of the first to fourth input image signals IDAT1, IDAT2, IDAT3 and IDAT4, and may generate and output an interpolation frame image signal, in which a motion is interpolated based on the first to fourth input image signals IDAT1, IDAT2, IDAT3 and IDAT4 of a current frame and the first to fourth input image signals IDAT1, IDAT2, IDAT3 and IDAT4 of a previous frame. In such an embodiment, the first input image signal IDAT1 may have a resolution of 960×160 at a frame frequency of about 60 Hz, and the first data processing circuit 810 generates and outputs an interpolation frame image signal, in which a motion is interpolated between the current frame and the previous frame to output a first modified input image signal corresponding to the first display block DA1 at a frame frequency of about 120 Hz, which includes the input image signal of the current frame and the interpolation frame image signal.

In such an embodiment, the second to fourth data processing circuits 820, 830 and 840 may output second to fourth modified input image signals having a resolution of 960×160 corresponding to the second to fourth display block DA2, DA3 and DA4 of the display panel 300 under a driving mode described above with respect to the first data processing circuit 810.

The first to the fourth signal control circuits 610 620, 630 and 640 of the signal controller 600 may process the first to second modified input image signals having a resolution of 960×160 at a frame frequency of about 120 Hz, respectively such that the display panel 300 may display a frame image having a resolution of 3840×160 at a frame frequency of about 120 Hz.

In an exemplary embodiment, the data processor 800 and the signal controller 600 transmit or process the signals using the synchronization control signal ICON_Sync generated in the synchronization unit 700 of the data preprocessor 1000, and the output image signals DAT inputted to the first to fourth display blocks DA1, DA2, DA3 and DA4 may also be synchronized with each other to be supplied to the display panel 300.

In an exemplary embodiment, the master clock signal MCLK of the synchronization control signal ICON_Sync controls the driving of the data driver (not shown) of the display panel 300 to synchronize a driving timing of a data driving circuit which drives the first to fourth display blocks DA1, DA2, DA3 and DA4.

According to the exemplary embodiments of the invention as described herein, display quality is prevented from being deteriorated due to asynchronization by efficiently synchronizing image signals or control signals, which are inputted through a plurality of channels or a plurality of TMDS links, with each other.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving device, comprising:
a synchronization unit which receives a plurality of input control signals and a plurality of input image signals during a frame through a plurality of channels, wherein the synchronization unit generates and outputs a synchronization control signal of the plurality of input image signals based on the plurality of input control signals; and
a signal controller which receives the plurality of input control signals and the synchronization control signal from the synchronization unit.

2. The driving device of claim 1, wherein the synchronization unit comprises:
a plurality of receivers which receives the plurality of input control signals and the plurality of input image signals through the plurality of channels, respectively; and
a synchronization buffer which receives the plurality of input control signals from the plurality of receivers and generates the synchronization control signal,
wherein the synchronization buffer is synchronized with the synchronization control signal and outputs the plurality of input image signals.

3. The driving device of claim 2, wherein the synchronization buffer comprises:
a plurality of controllers which receives the plurality of input control signals, and the plurality of input image signals synchronized with the plurality of input control signals, from the plurality of receivers, respectively; and
a synchronization signal generator which generates the synchronization control signal based on the plurality of input control signals.

4. The driving device of claim 3, wherein
the synchronization buffer further comprises a plurality of memories,
the plurality of controllers stores the plurality of input image signals in the plurality of memories, respectively, and
the plurality of memories receives the synchronization control signal and outputs the plurality of input image signals in synchronization with the synchronization control signal.

5. The driving device of claim 4, wherein:
the plurality of input control signals includes a plurality of data enable signals,
the plurality of controllers generates a plurality of flag signals based on the plurality of data enable signals, respectively, and transmits the plurality of flag signals to the synchronization signal generator, and
the synchronization control signal includes a synchronized data enable signal.

6. The driving device of claim 5, wherein:
the plurality of input control signals includes a plurality of clock signals, and
the synchronization control signal includes a master clock signal, which is defined as one of the plurality of clock signals.

7. The driving device of claim 6, further comprising:
a data processor which receives and processes the synchronization control signal and the plurality of input image signals from the synchronization unit,
wherein the data processor transmits the processed synchronization control signal and the processed plurality of input image signals to the signal controller.

8. A display device, comprising:
a synchronization unit which receives a plurality of input control signals and a plurality of input image signals during a frame through a plurality of channels, wherein the synchronization unit generates and outputs a synchronization control signal of the plurality of input image signals based on the plurality of input control signals;
a signal controller which receives and processes the plurality of input control signals and the synchronization control signal from the synchronization unit, wherein the signal controller outputs a driving control signal and an output image signal; and
a display panel which receives the driving control signal and the output image signal from the signal controller to display an image.

9. The display device of claim 8, wherein the synchronization unit comprises:
a plurality of receivers which receives the plurality of input control signals and the plurality of input image signals through the plurality of channels, respectively; and
a synchronization buffer which receives the plurality of input control signals from the receivers and generates the synchronization control signal,
wherein the synchronization buffer is synchronized with the synchronization control signal and outputs the plurality of input image signals.

10. The display device of claim 9, wherein the synchronization buffer comprises:
a plurality of controllers which receives the plurality of input control signals, and the plurality of input image signals synchronized with the plurality of input control signals, from the plurality of receivers, respectively; and
a synchronization signal generator which generates the synchronization control signal based on the plurality of input control signals.

11. The display device of claim 10, wherein
the synchronization buffer further comprises a plurality of memories,
the plurality of controllers stores the plurality of input image signals in the plurality of memories, respectively, and
the plurality of memories receives the synchronization control signal and outputs the plurality of input image signals in synchronization with the synchronization control signal.

12. The display device of claim 11, wherein
the plurality of input control signals includes a plurality of data enable signals,
the plurality of controllers generates a plurality of flag signals based on the plurality of data enable signals, respectively, and transmits the plurality of flag signals to the synchronization signal generator, and
the synchronization control signal includes a synchronized data enable signal.

13. The display device of claim 12, wherein
the plurality of input control signals includes a plurality of clock signals, and
the synchronization control signal includes a master clock signal, which is defined as one of the plurality of clock signals.

14. The display device of claim 13, further comprising:
a data processor which receives and processes the synchronization control signal and the plurality of input image signals from the synchronization unit,
wherein the data processor transmits the processed signals to the signal controller.

15. The display device of claim 14, wherein
the display panel includes a plurality of display blocks,
the data processor comprises a plurality of data processing circuits which process input image signals such that the processed input image signals are respectively displayed in each of the plurality of display blocks,
the signal controller comprises a plurality of signal control circuits connected to the plurality of data processing circuits, respectively, and
the synchronization unit transmits the synchronization control signal and the input image signals corresponding to the plurality of display blocks, respectively, to the plurality of data processing circuits.

16. The display device of claim 15, wherein the synchronization buffer comprises a line memory.

17. A driving method of a display device, the method comprising:
receiving a plurality of input control signals and a plurality of input image signals through a plurality of channels, respectively, by a plurality of receivers;
receiving the plurality of input control signals from the plurality of receivers by a synchronization buffer;
generating and outputting a synchronization control signal of the plurality of input image signals based on the plurality of input control signals by the synchronization buffer; and
receiving the plurality of input control signals and the synchronization control signal from the synchronization buffer by a signal controller.

18. The driving method of a display device of claim 17, wherein
the plurality of receivers receive the plurality of input image signals in synchronization with the plurality of input control signals, respectively, and
the synchronization buffer is synchronized with the synchronization control signal to output the plurality of input image signals.

19. The driving method of a display device of claim 18, further comprising:
storing the plurality of input image signals in a plurality of memories of the synchronization buffer, respectively, by the plurality of controllers of the synchronization buffer;
receiving the synchronization control signal by the plurality of memories; and
outputting the plurality of input image signals in synchronization with the synchronization control signal by the plurality of memories.

20. The driving method of a display device of claim 19, further comprising:
receiving and processing the synchronization control signal and the plurality of input image signals from the synchronization unit by a data processor; and
transmitting the processed signals from the data processor to the signal controller.
